(19) United States
(12) Patent Application Publication
(10) Pub. No.: US 2016/0153498 A1
(43) Pub. Date: Jun. 2, 2016

(54) ROLLING BEARING ASSEMBLY

(71) Applicant: Anthony SIMONIN, Tours (FR)

(72) Inventor: Anthony SIMONIN, Tours (FR)

(73) Assignee: Aktiebolaget SKF, Goteborg (SE)

(21) Appl. No.: 14/951,492

(22) Filed: Nov. 25, 2015

(30) Foreign Application Priority Data
Nov. 28, 2014 (EP) 14306915.1

(51) Int. Cl. F16C 41/00; F16C 33/30; F16C 19/52; F16C 19/16

(52) U.S. Cl. CPC F16C 41/00; F16C 19/16; F16C 33/30; F16C 19/525

(57) ABSTRACT

A rolling bearing assembly comprises a bearing including a rotating ring and a stationary ring, a sleeve in which the stationary ring of the bearing is mounted, a housing in which the sleeve is mounted, a shaft with which the rotating ring of the bearing is coupled in rotation with respect to the housing and a sensor unit including an impulse ring coupled in rotation to the rotating ring and a sensing unit comprising at least one sensing element mounted in a sensor body. The sleeve, on the one hand, supports both the stationary ring of the bearing and the sensor body and, on the other hand, compensates thermal dilatations between the housing and the stationary ring.

### CROSS REFERENCE TO RELATED APPLICATIONS

This is a Non-Provisional Patent Application, filed under the Paris Convention, claiming the benefit of Europe (EP) Patent Application Number 14306915.1, filed on 28 Nov. 2014 (28 Nov 2014), which is incorporated herein by reference in its entirety.

### TECHNICAL FIELD OF THE INVENTION

The invention concerns a rolling bearing assembly.

### BACKGROUND OF THE INVENTION

Sensor bearing units, for example on two-wheelers, generally comprise a bearing and a sensor unit mounted in a housing. The housing is often made of a light metallic alloy including aluminum. At high temperatures, a clearance provoked by thermal dilatation can appear between the housing and the outer ring of the bearing. In such a case, the sensor body could rotate with respect to the housing.

It is known to avoid the clearance by using a steel bushing or sleeve arranged between the housing and the outer ring of the bearing. Some solutions also imply a plastic cap. The steel bushing or the plastic cap is assembled in the housing and the bearing or the sensor bearing is assembled inside the steel bushing or the plastic cap.

The plastic cap has a poor thermal dissipation capacity and increases the temperature of the bearing. The steel bushing is generally mounted first in the housing then the sensor bearing is mounted. This proves difficult because of the steel bushing often comprises a radial portion on one side which make uneasy the integration of the cable output.

### SUMMARY OF THE INVENTION

The aim of the invention is to provide an improved rolling bearing assembly, in which the integration of a sensor unit is easier.

To this end, the invention concerns a rolling bearing assembly, comprising a bearing including a rotating ring and a stationary ring, a sleeve in which the stationary ring of the bearing is mounted, a housing in which the sleeve is mounted, a shaft with which the rotating ring of the bearing is coupled in rotation with respect to the housing and a sensor unit including an impulse ring coupled in rotation to the rotating ring and a sensing unit comprising at least one sensing element mounted in a sensor body. This rolling bearing assembly is characterized in that the sleeve, on the one hand, supports both the stationary ring of the bearing and the sensor body and, on the other hand, compensates thermal dilatations between the housing and the stationary ring.

Thanks to the invention, the integration of the sensor unit is easier than in the prior art assemblies, and improves the liability of the rolling bearing assembly.

According to further aspects of the invention which are advantageous but not compulsory, such a rolling bearing assembly may incorporate one or several of the following features:
The sensor body is mounted axially between the bearing and a radially extending portion of the sleeve.
The sensor body comprises a peripheral groove in which an inwardly extending radial portion of the sleeve is received.
The rolling bearing assembly comprises a pre-stressing element for pre-stressing the stationary ring, adapted to exert a pre-stressing force between the housing and the stationary ring.
The pre-stressing element is mounted in a chamber extending between an axial surface of the sensor body and a radial portion of the sleeve.
The pre-stressing element is a wavy spring.
The sensor body is attached to the sleeve by means selected amongst over molding, elastic mounting, gluing or welding.
The sensor unit is adapted to transmit sensed data via wire transmission.
The sensor unit comprises an axial transmission cable output.
The sensor unit comprises a radial transmission cable output.
The sensor unit is adapted to transmit sensed data via wireless transmission.
The housing and/or the sleeve are made of a synthetic material.
The housing and/or the sleeve are made of polyethylene terephthalate.

### BRIEF DESCRIPTION OF THE DRAWINGS

The invention will now be explained in correspondence with the annexed figures, and as an illustrative example, without restricting the object of the invention. In the annexed figures:

FIG. 1 is a longitudinal sectional view of a rolling bearing assembly according to the invention;

FIG. 2 is a view at a larger scale of detail II on FIG. 1;

FIG. 3 is an exploded perspective view of the rolling bearing assembly of FIGS. 1 and 2;

FIG. 4 is a perspective view of a bearing, a sensor body and a preloading element belonging to the rolling bearing assembly of FIGS. 1 to 3;

FIG. 5 is an partially exploded view of the bearing, the sensor body and the preloading element of FIG. 4; and

FIGS. 6 and 7 are view similar to FIGS. 4 and 5, for a rolling bearing assembly according to a second embodiment of the invention.

### DETAILED DESCRIPTION OF SOME EMBODIMENTS

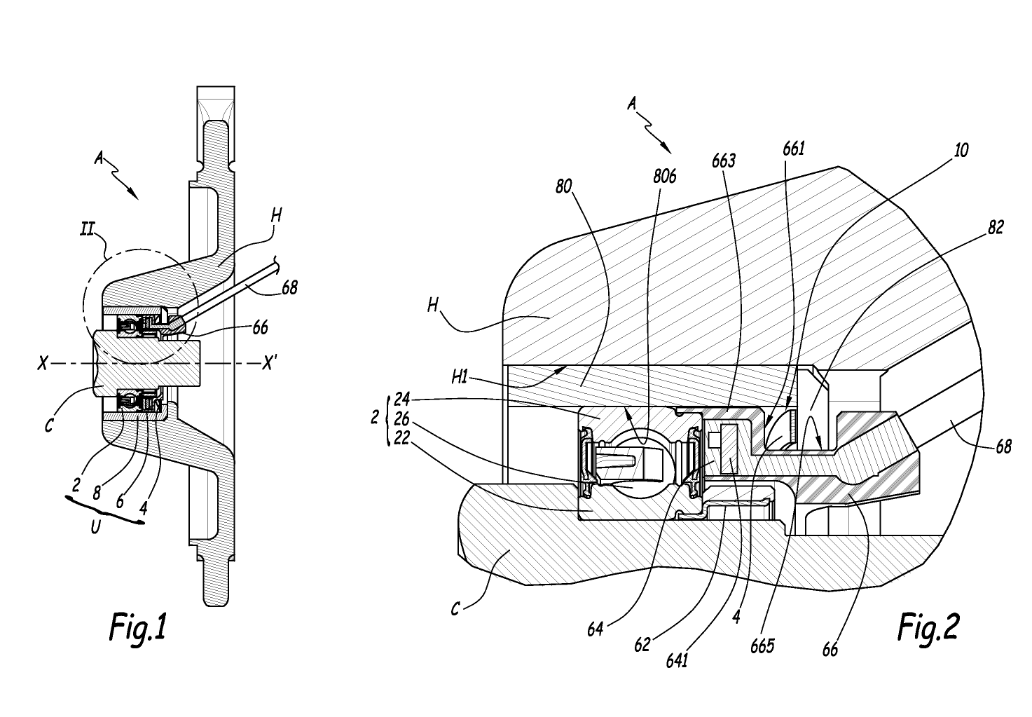

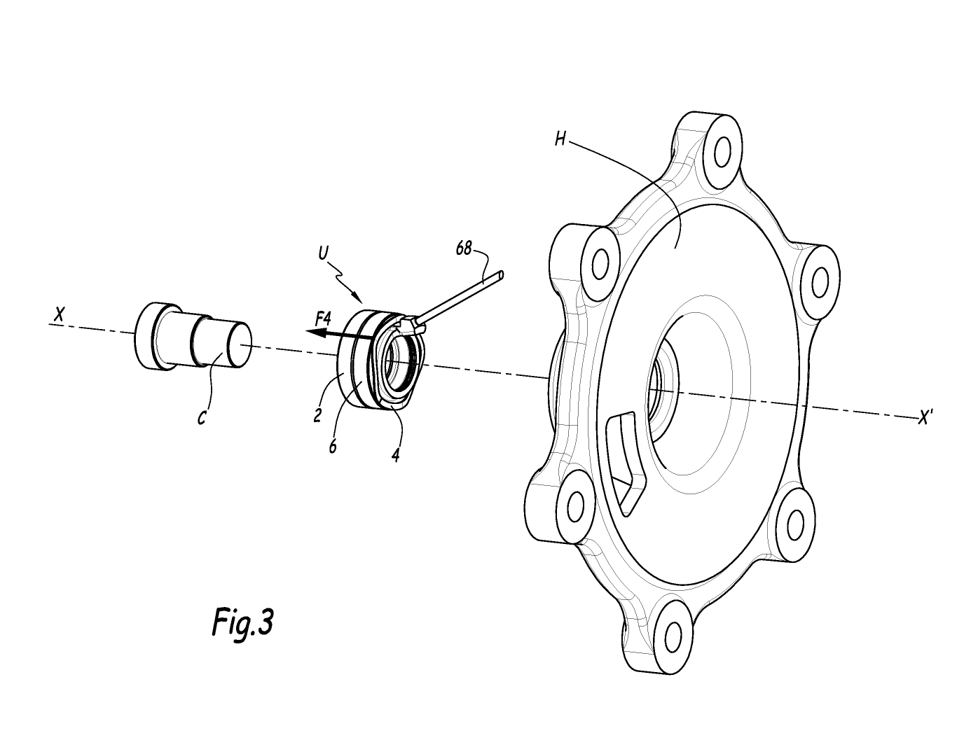

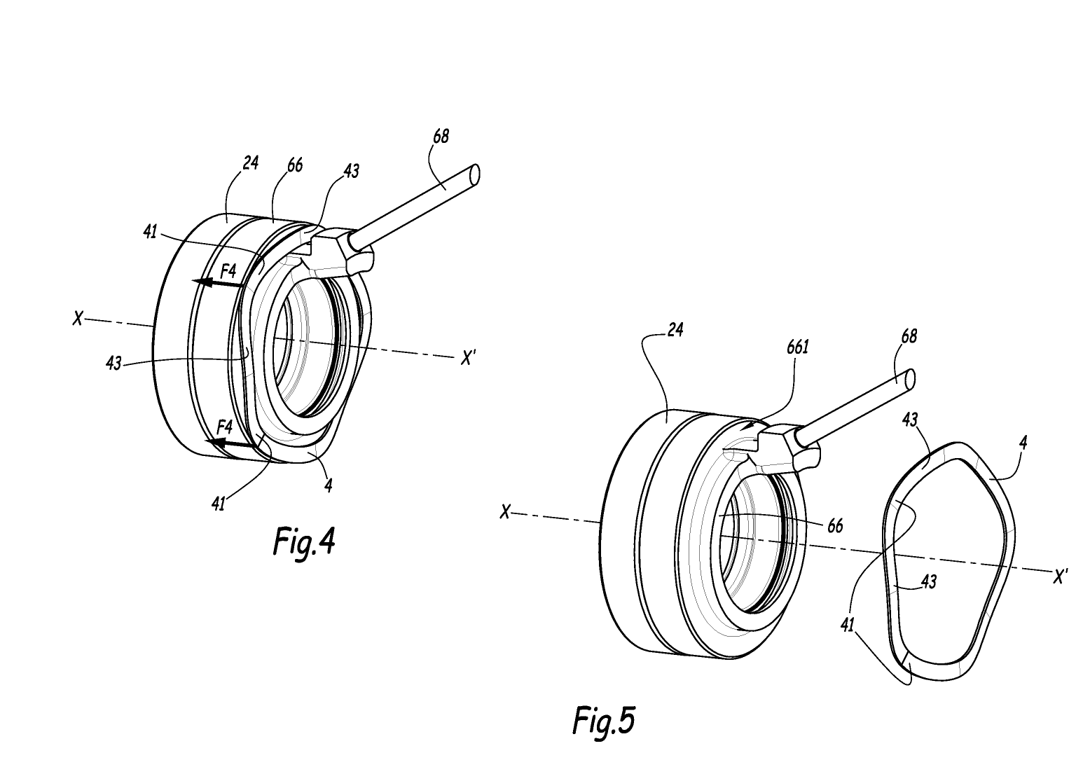

The rolling bearing assembly A represented on FIG. 1 is adapted to be mounted on an automotive vehicle, such as a motorcycle. The rolling bearing assembly A comprises a shaft C, a housing H and a sensor bearing unit U.

The rolling bearing assembly A defines a central rotation axis X-X′. In this description, the words “axial” and “radial” are used in reference to axis X-X′.

The sensor-bearing unit U comprises a rolling bearing 2 including a rotating ring 22 and a stationary ring 24. In the example, the rotating ring 22 is the inner ring, while the stationary ring 24 is the outer ring. The rolling bearing 2 also includes rolling elements which are balls 26 in this example.

In a non-shown embodiment, the rolling bearing 2 may comprise another type of rolling elements, such as rollers or needles.

The sensor bearing unit U comprises a sensor unit 6 which includes an impulse ring 62 coupled in rotation to the rotating ring 22 and a sensing unit 64 comprising at least one sensing element 641 mounted in a sensor body 66 which is fixed to the stationary ring 24.

The sensor body 66 comprises an axial surface 661 against which the pre-stressing element 4 exerts the pre-stressing force F4. The sensor body 66 transmits the pre-stressing force F4 to the stationary ring 24 thanks to an axial portion 663 which connects the axial surface 661 to the stationary ring 24.

The sensor-bearing unit U includes a sleeve 8 in which the bearing 2 and the sensor body 66 are mounted. The sleeve 8 comprises a cylindrical portion 80 mounted in a bore H1 of the housing H. The cylindrical portion 80 defines an inner bore 800, against which the stationary ring 24 is mounted, the sleeve 8 thereby providing a support for the stationary ring 24.

The sleeve 8 aims at compensating the effects of thermal dilatation, which can cause the bore H1 to enlarge and provoke a clearance between the stationary ring 24 and the housing H.

The mounting of the sensor body 66 on the sleeve 8 facilitates the assembly of the rolling bearing assembly A.

The sleeve 8 is made of a metallic material such as steel.

As an alternative, the sleeve 8 can be made of a synthetic material, such as polyethylene terephthalate (PET). Such a material is light, not much expensive, provides electric isolation properties and is suitable for compensating dilatation of metallic rings such as the outer ring 24.

The housing H may also be made of a synthetic material such as PET. The housing H and the sleeve 8 may both be made of a synthetic material, or only one of the housing H and the sleeve 8 may be made of a synthetic material.

The sensor body 66 may be attached to the sleeve 8 by any convenient means selected amongst, for example, over molding, elastic mounting, gluing or welding.

The sensor unit 6 is adapted to transmit sensed data via wire transmission. The sensor unit 6 therefore comprises an output transmission cable 68. In this example, the cable 68 extends in a slightly angled axial direction. As a non-shown embodiment, the output cable 68 may extend in a purely axial direction.

The sensor bearing unit U further includes an optional pre-stressing element 4 for pre-stressing the stationary ring 24, adapted to exert a pre-stressing force F4 between the housing H and the stationary ring 24. In the example, the pre-stressing element 4 is a wavy spring.

The sleeve 8 comprises an inwardly extending radial portion 82 against which the pre-stressing element 4 is in contact. The axial surface 661 of the sensor body 66 and the radial portion 82 of the sleeve 8 form a chamber in which the pre-stressing element 4 is mounted. The radial portion 82 extends in a circumferential groove 665 of the sensor body 66, which defines the axial surface 661.

The pre-stressing element 4 comprises alternated waves 41, which are in contact with axial surface 661, and 43, which are in contact with radial portion 82.

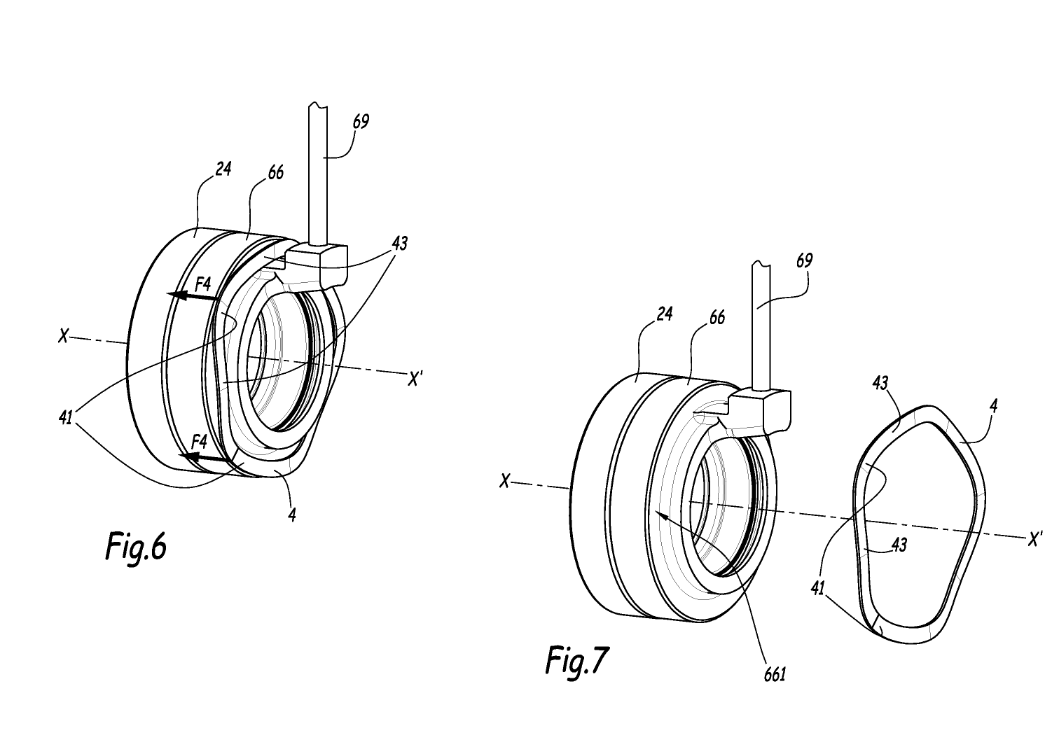

A second embodiment of the invention is represented on FIGS. 6 and 7. In this embodiment, elements similar to the first embodiment have the same references and work in the same way. Only the differences with respect to the first embodiment are described hereafter.

In this embodiment, the sensor unit 6 comprises an output transmission cable 69 which extend in a radial direction.

According to a non-shown embodiment, the sensor bearing unit U may comprise no pre-stressing element 4.

According to a non-shown embodiment, the sensor unit 6 is adapted to transmit sensed data via wireless transmission.

According to another non-shown embodiment, the sensor body 66 may be as a whole inserted axially between the bearing 2 and the radial portion 82.

In addition, technical features of the different embodiments can be, in whole or part, combined with each other to form new embodiments of the invention.

What is claimed is:

1. A rolling bearing assembly, comprising:
a bearing including a rotating ring and a stationary ring;
a sleeve in which the stationary ring of the bearing is mounted;
a housing in which the sleeve is mounted;
a shaft with which the rotating ring of the bearing is coupled in rotation with respect to the housing; and
a sensor unit including an impulse ring coupled in rotation to the rotating ring and a sensing unit comprising at least one sensing element mounted in a sensor body,
wherein the sleeve supports both the stationary ring of the bearing and the sensor body, and
wherein the sleeve compensates thermal dilatations between the housing and the stationary ring.

2. The rolling bearing assembly according to claim 1, wherein the sensor body is mounted axially between the bearing and a radially extending portion of the sleeve.

3. The rolling bearing assembly according to claim 1, the sensor body further comprising a peripheral groove, in which, an inwardly extending radial portion of the sleeve is received.

4. The rolling bearing assembly according to claim 1, further comprising a pre-stressing element for pre-stressing the stationary ring, adapted to exert a pre-stressing force between the housing and the stationary ring.

5. The rolling bearing assembly according to claim 4, wherein the pre-stressing element is mounted in a chamber extending between an axial surface of the sensor body and a radial portion of the sleeve.

6. The rolling bearing assembly according to claim 5, wherein the pre-stressing element is a wavy spring.

7. The rolling bearing assembly according to claim 1, wherein the sensor body is attached to the sleeve by an attachment element, wherein the attachment element is selected amongst over molding, elastic mounting, gluing and welding.

8. The rolling bearing assembly according to claim 1, wherein the sensor unit is adapted to transmit sensed data via a wire transmission.

9. The rolling bearing assembly according to claim 8, the sensor unit further comprising an axial transmission cable output.

10. The rolling bearing assembly according to claim 8, the sensor unit further comprising a radial transmission cable output.

11. The rolling bearing assembly according to claim 1, wherein at least one of the housing and the sleeve is made of a synthetic material.

12. The rolling bearing assembly according to claim 12, wherein the at least one of the housing and the sleeve is made of polyethylene terephthalate.
